(19) United States
(12) Patent Application Publication
(10) Pub. No.: US 2014/0052664 A1
(43) Pub. Date: Feb. 20, 2014

(54) Map-authoring applications and geogames

(71) Applicant: CrabDish Inc., dba uMapper.com, Greenwood Village, CO (US)

(72) Inventors: Antoine Toffa, Englewood, CO (US); Andrei Taraschuk, Aurora, CO (US); Dmitry Stolyarov, Chelyabinsk (RU)

(73) Assignee: CrabDish Inc., dba uMapper.com, Greenwood Village, CO (US)

(21) Appl. No.: 13/998,336

(22) Filed: Oct. 22, 2013

Related U.S. Application Data
(62) Division of application No. 12/800,099, filed on May 6, 2010.
(60) Provisional application No. 61/215,604, filed on May 6, 2009.

(51) Int. Cl. G01C 21/26; G06Q 50/16; A63F 13/00

(52) U.S. Cl. CPC G01C 21/26; A63F 13/005; G06Q 50/16
USPC 705/347; 701/538; 463/31

(57) ABSTRACT

The present invention provides methods, devices, and systems for allowing a novice user to create, manage, and distribute maps, map-based games, and simulations in any environment, with map tiles from any map provider. Users are allowed to make and manage such maps with a universal map-authoring application, thereby increasing its desirability among other novice users.

### CROSS-REFERENCE TO RELATED APPLICATIONS

This Application claims the benefit of U.S. Provisional Application No. 61/215,604, filed May 6, 2009, the entire disclosure of which is hereby incorporated herein by reference.

### FIELD OF THE INVENTION

The invention relates generally to computer-based applications and more particularly to map-based applications.

### REFERENCE TO A COMPUTER PROGRAM LISTING APPENDIX

A single compact disc containing computer code for executing various classes in accordance with at least some embodiments of the present invention is being filed concurrently herewith in accordance with 37 CFR§1.52(e)(5) and is incorporated by reference in its entirety herein.

### BACKGROUND

The creation of maps, particularly computer-based maps, has been a tedious and drawn-out task usually reserved for the most expert programmer. This has been the historical trend due to the inherent complexity of maps and the amount of data represented by a map. However, with the proliferation of the Internet, more and more users are developing a need to view customized maps. Some service providers such as MapQuest, Google, Microsoft, and the like have developed web-based maps that can be viewed by online users. The map tiles provided by these service providers contain a vast amount of data and are, therefore, very difficult to leverage beyond viewing particular locations. Some of these service providers, however, allow a user to get directions from one location to another location or view street level images from a particular location (i.e., tie a series of street-level images to a predetermined geolocation). Beyond these basic uses the map data provided by the map service providers cannot be leveraged by the typical Internet consumer.

### SUMMARY

These and other needs have been addressed by embodiments of the present invention. More specifically, embodiments of the present invention provide a mechanism which allows novice Internet users to create, manage, and control their own maps and applications that leverage map data. More specifically, a web-based map-authoring application is provided that can use any map tile from any map provider (e.g., Microsoft Virtual Earth maps, Google Maps, Yahoo Maps, OpenStreet Maps, CloudMade maps, DigitalGlobe, ESRI, custom maps, etc.) and switch from one type of map tile (or between service providers) to another type of map tile instantaneously and effortlessly.

It is another aspect of the present invention to provide a mapping platform that allows any user to create map-based games (geogames) and online geography-based simulations. A geogame is any type of game or simulation based on a real, interactive (i.e., allows the player to zoom-in, zoom-out, find locations, etc. as if they were simply viewing the map without the game or application on top of it), online and offline map (i.e., based on satellite imagery as opposed to being based on an artist's drawing).

It is yet another aspect of the present invention to provide a map player, similar to an audio player or video player, that is used to play custom animated maps and geogames. A map player is a particular application or module that enables the spatial visualization of a time-based series of events on a map (e.g., the spread of a particular strain of flu across a map or the number of votes being tallied at certain locations during an election). With a map player, a user can visualize the evolution of such events on a map with actual map data.

It is yet another aspect of the present invention to provide an application programming interface (API) which allows a novice user to create a customized application with actual map data underneath. More specifically, an editing application may serve as the user interface which allows the user to select geometric shapes, text, photos, video, graphics, etc. to be displayed on a map or within the boundaries of a location on a map, rules of how and when such content should be displayed, rules governing a user's interaction with the map data when using the customized map, and so on. The API is capable of defining web-based services, route algorithms, street layers, GPS feeds, live traffic feeds, weather feeds, KML, ad overlays, and the like. Some of the data in the API may or may not be accessible by the user via the editing application. Both the API and the editing application may be provided on top of one or more map tiles or different types of map tiles from different map providers.

In accordance with at least some embodiments of the present invention, a method is provided that generally comprises:

receiving user instructions to create a new map using map data;

receiving user instructions to mark a first location on the new map;

associating the first location marked by the user and a corresponding location in the map data;

receiving user instructions for assigning properties to the first location; and

assigning the properties to the first location marked by the user and the corresponding location in the map data.

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read: A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine,” “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a communication system in accordance with embodiments of the present invention;

FIG. 2 is a first depiction of an exemplary user interface when playing a geogames in accordance with embodiments of the present invention;

FIG. 3 is a second depiction of an exemplary user interface when playing a geogames in accordance with embodiments of the present invention;

FIG. 4 is a third depiction of an exemplary user interface when playing a geogames in accordance with embodiments of the present invention;

FIG. 5 is a fourth depiction of an exemplary user interface when playing a geogames in accordance with embodiments of the present invention;

FIG. 6 is a fifth depiction of an exemplary user interface when playing a geogames in accordance with embodiments of the present invention;

FIG. 7 is a sixth depiction of an exemplary user interface when playing a geogames in accordance with embodiments of the present invention;

FIG. 8 is a screen-capture of a web-based user interface for creating a customized geogames in accordance with embodiments of the present invention;

FIG. 9 is a first depiction of an exemplary user interface for creating a customized geogame in accordance with embodiments of the present invention;

FIG. 10 is a second depiction of an exemplary user interface for creating a customized geogame in accordance with embodiments of the present invention;

FIG. 11 is a third depiction of an exemplary user interface for creating a customized geogame in accordance with embodiments of the present invention;

FIG. 12 is a fourth depiction of an exemplary user interface for creating a customized geogame in accordance with embodiments of the present invention;

FIG. 13 is a fifth depiction of an exemplary user interface for creating a customized geogame in accordance with embodiments of the present invention;

FIG. 14 is a sixth depiction of an exemplary user interface for creating a customized geogame in accordance with embodiments of the present invention;

FIG. 15 is a seventh depiction of an exemplary user interface for creating a customized geogame in accordance with embodiments of the present invention;

FIG. 16 is a flow chart depicting a method of creating a geogame or customized map in accordance with at least some embodiments of the present invention;

FIG. 17 is a screen shot depicting a secured map in accordance with at least some embodiments of the present invention;

FIG. 18 is a logical block diagram depicting the interaction of an editing user interface, an API, and map tiles in accordance with at least some embodiments of the present invention; and

FIG. 19 is a logical block diagram depicting the flow of information and data to/from a customized map or geogame in accordance with at least some embodiments of the present invention.

### DETAILED DESCRIPTION

The invention will be illustrated below in conjunction with an exemplary communication system. Although well suited for use with, e.g., a system using a server(s) and/or database(s), the invention is not limited to use with any particular type of communication system or configuration of system elements. Those skilled in the art will recognize that the disclosed techniques may be used in any communication application in which it is desirable to create customized maps and/or map-based games and simulations.

The exemplary systems and methods of this invention will also be described in relation to communications software, modules, and associated communication hardware. However, to avoid unnecessarily obscuring the present invention, the following description omits well-known structures, network components and devices that may be shown in block diagram form, are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communication network and/or the Internet, or within a dedicated secure, unsecured and/or encrypted system. Thus, it should be appreciated that the components of the system can be combined into one or more devices, such as an enterprise server or collocated on a particular node of a distributed network, such as an analog and/or digital communication network. As will be appreciated from the following description, and for reasons of computational efficiency, the components of the system can be arranged at any location within a distributed network without affecting the operation of the system. For example, the various components can be located in a local server, at one or more users' premises, or some combination thereof

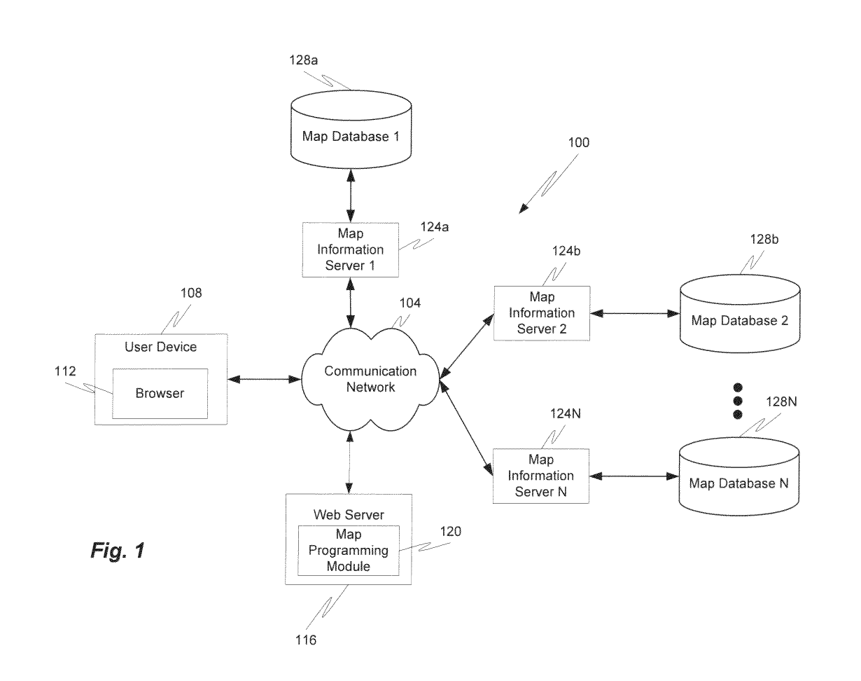

Referring now to FIG. 1, an exemplary communication system 100 will be described in accordance with at least some embodiments of the present invention. The communication system 100 may comprise a communication network 104 that facilitates communications between one or more communication devices, such as a user device 108, a web server 124, an index server 132, and/or a document server 136.

The communication network 104 may be any type of known communication medium or collection of communication mediums and may use any type of protocols to transport messages between endpoints. The communication network 104 may include wired and/or wireless communication technologies. The Internet is an example of the communication network 104 that constitutes and IP network consisting of many computers and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), an enterprise network, and any other type of packet-switched or circuit-switched network known in the art. In addition, it can be appreciated that the communication network 104 need not be limited to any one network type, and instead may be comprised of a number of different networks and/or network types.

The user device 108 may be any type of known communication or processing device such as a personal computer, laptop, Personal Digital Assistant (PDA), cellular phone, smart phone, telephone, contact center resource, DCP phone, analog phone, or combinations thereof The user devices 108 may be controlled by or associated with a single user or may be adapted for use by many users (e.g., an enterprise communication device that allows any enterprise user to utilize the communication device upon presentation of a valid user name and password). In general, each user device 108 may be adapted to support video, audio, text, and/or data communications with other user devices 108. The type of medium used by the user device 108 to communicate with other communication devices may depend upon the communication applications available on the user device 108.

The user device 108 may comprise a browser 112 that allows a user to browse and communicate with other devices connected to the communication network 104. As an example, the browser 112 may correspond to a web browser (e.g., Internet Explorer, Mozilla by Firefox, Google Chrome, or any other type of known web browser application). The browser 112 enables the user of the user device 108 to remotely access a web server 116 that contains a map programming module 116. As can be appreciated, however, a local map programming module may be provided on the user device 108 and may be accessible without the need for a browser 112.

The map programming module 120 allows the user to create customized maps, geogames, and map-based simulations with their own set of user rules. The user rules for the customized map, geogame, and/or simulation are applied to map data retrieved from one or more map information providers 124a-N. Each map information provider may provide actual map data (including geolocation information, satellite images, artist depictions of map data (e.g., streets, blocks, national borders, and other artificial boundaries), ground or street-level images associated with geolocations, and provider settings). The provider settings for a particular map provider 124 define the rules and restrictions with which a particular user can view and manipulate the rest of the map data. The web server 116 is adapted to retrieve such map data from the map provider 124 by referring to a particular URL or similar resource identifier. The web server 116 may provide a request for information associated with a particular URL and the map information server 124 may retrieve the map data pursuant to the request. All of this information may be retrieved from a map database 128a-N. Each map provider 124a-N may have a respective map database 128a-N associated therewith for storing map data and the like.

Once the map data has been transferred to the web server 116, the user is able to create and edit a customized map using the map programming module 120. Furthermore, the user can employ they map programming module 120 to create geogames based on the map data. Advantageously, a user can create customized maps and geogames based on map data from any one of the map providers 124 using the same map programming module 120. Furthermore, the user can create a customized map and/or geogame in connection with a particular set of map data (from a particular map provider) and can replace such data with map data from another map provider without altering any of the other rules used to create the customized map and/or geogame.

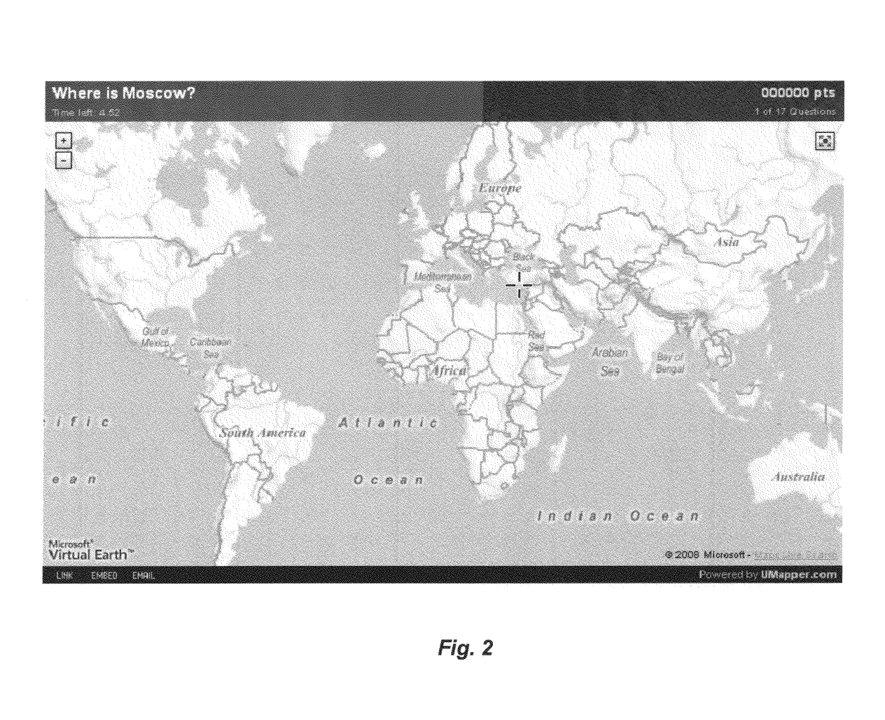

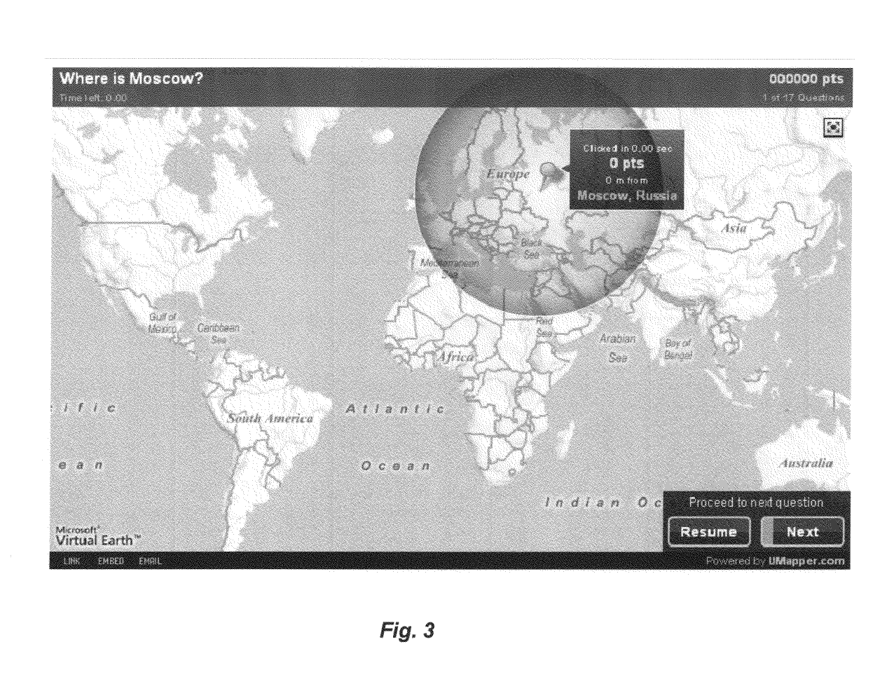

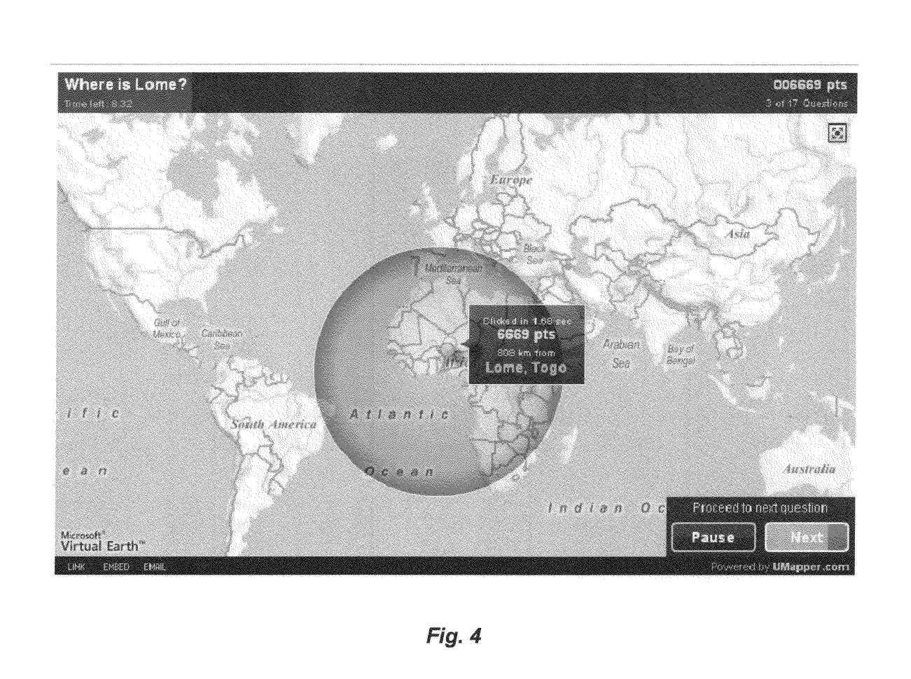

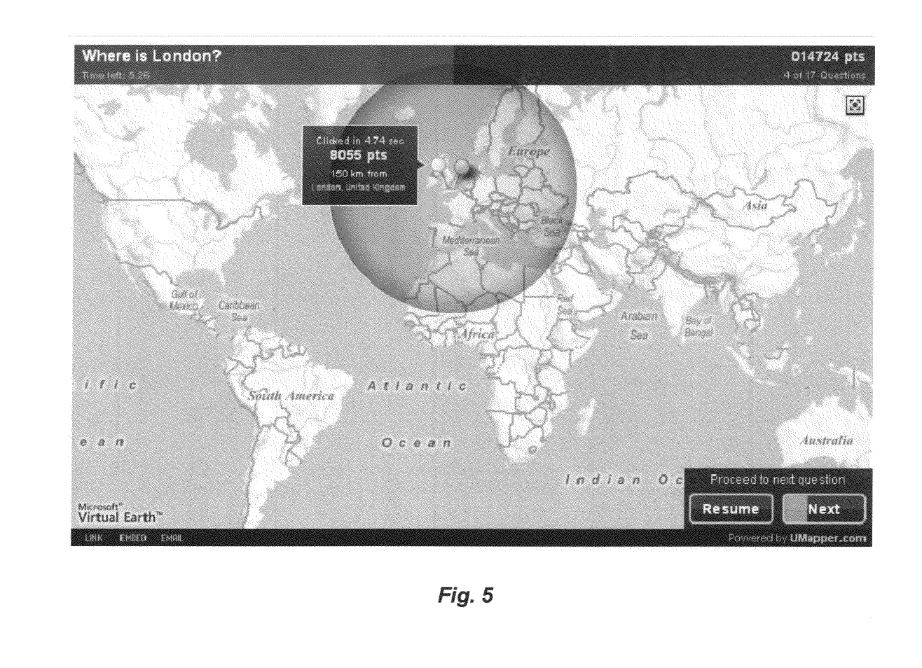

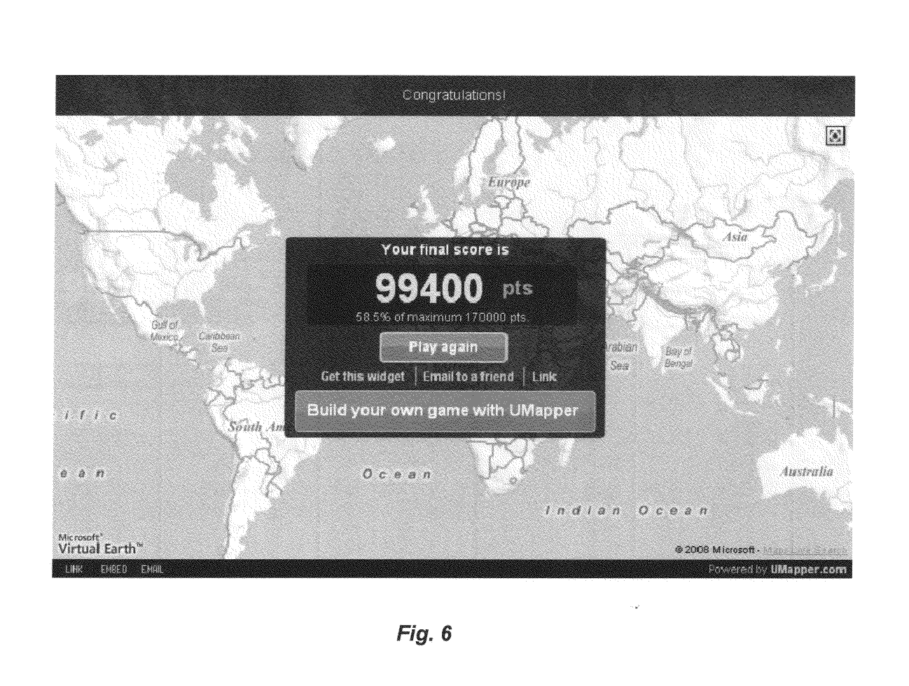

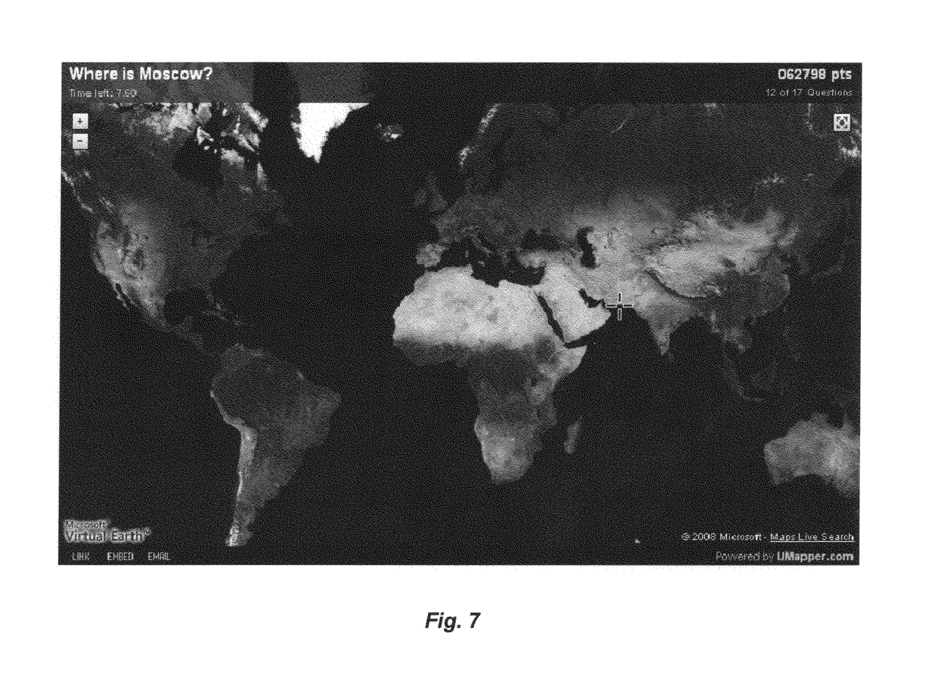

With reference now to FIGS. 2-7, an exemplary method of playing a customized geogame will be described in accordance with at least some embodiments of the present invention. A geogame may use actual map data that is based on actual geographic locations. In one example, an enhanced map image can be used as the base for a geogame. In another example, satellite images may be used as the base map image. The map image and the underlying map data can be provided from a map provider 124. A user is allowed to zoom-in, zoom-out, and control various views of the map image as if directly accessing the map data from the map provider. However, the geogame allows the user to apply a set of game rules (which have been defined by a user) on top of the map data. A geography quiz game is depicted in FIGS. 2-7 where a user is asked to click on the location of a particular capital. As part of the game rule set if the user does not click in a predetermined amount of time, then they are provided zero points. If, however, the user clicks within a predetermined radius of the location of a capital, then the user is assigned points based on the distance from the point where the player clicked and the point where the actual capital is located. Again, these rules are user-defined and can vary depending upon the game creator's preference.

Additional controls may be included in the geogame such as the ability to pause, resume, and end a game. Moreover, once a player has finished playing a game, the user may be provided with the option to play again, download the map programming module 120, email the customized game to a friend, provide the customized game to a friend as a link (e.g., provide a URL to the customized game), or build their own customized game.

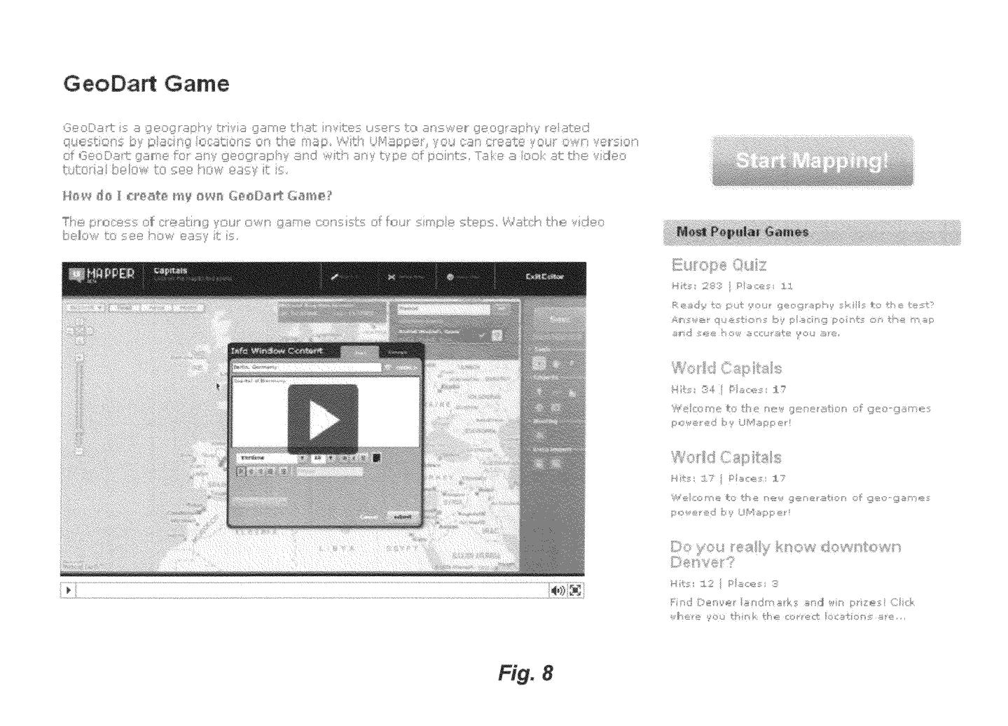

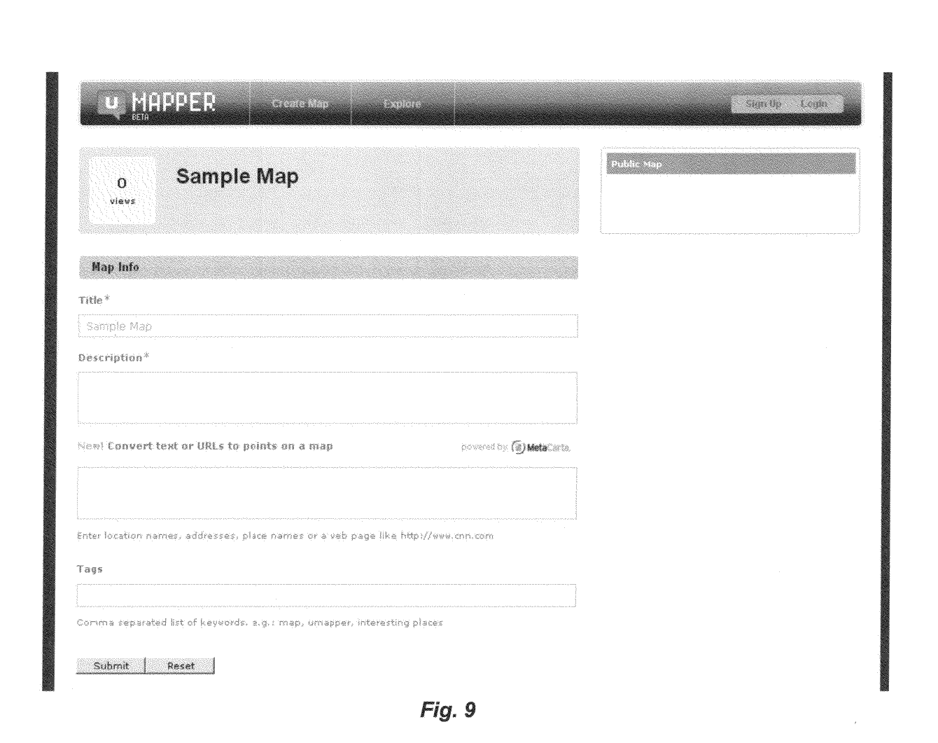

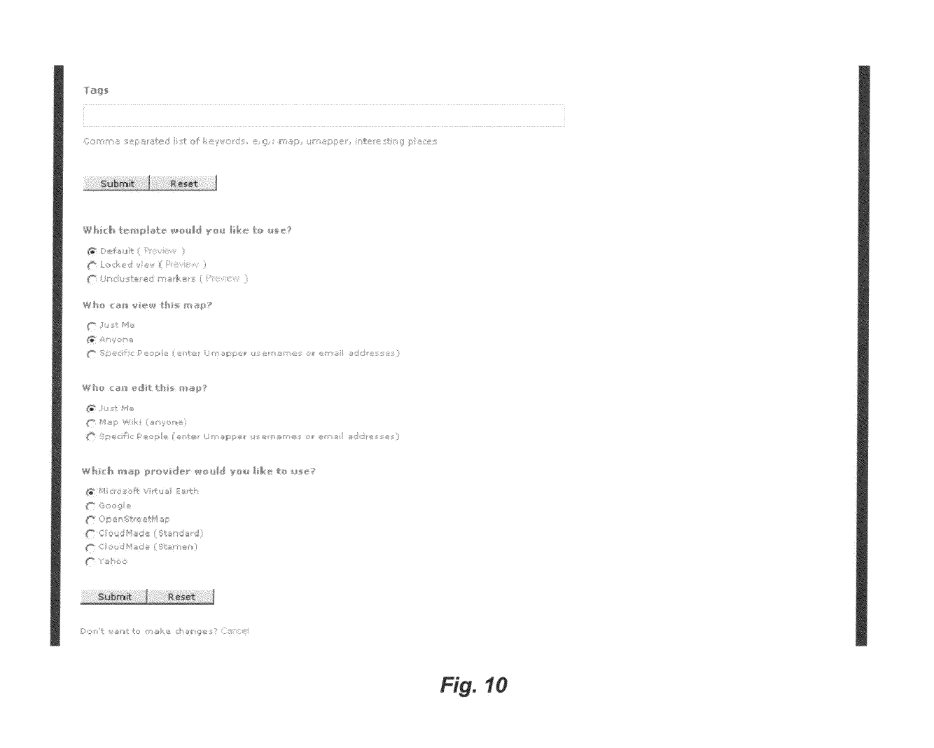

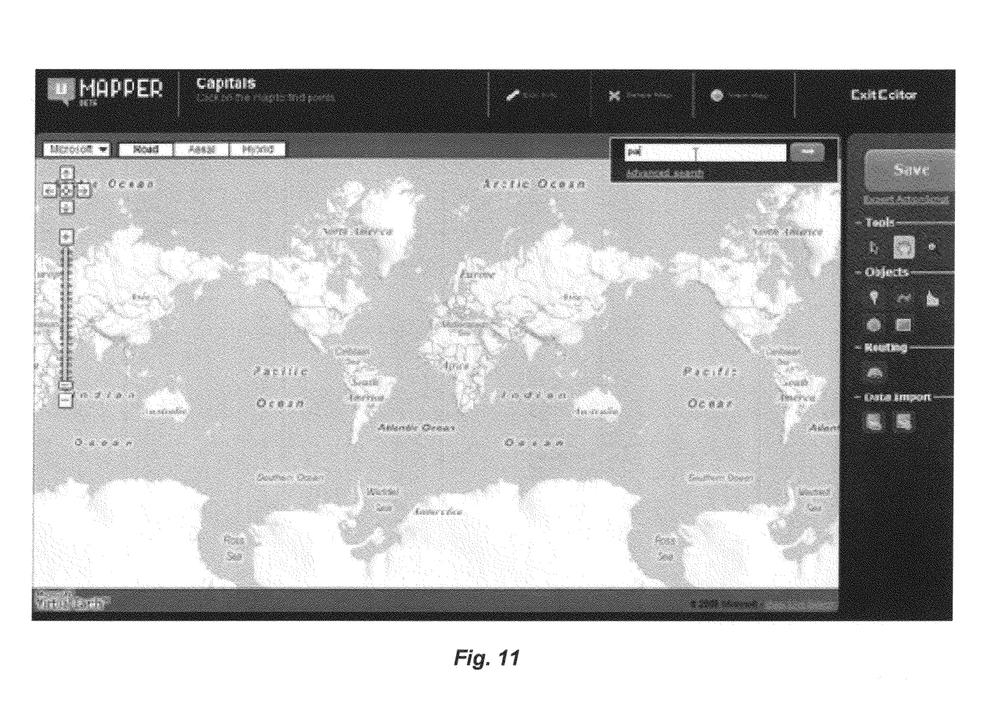

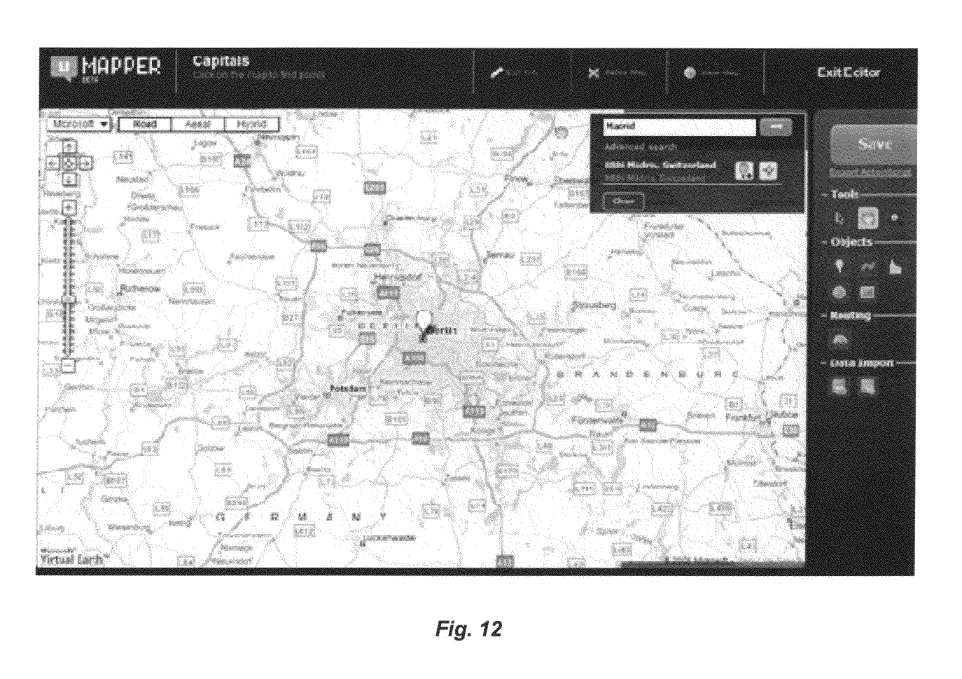

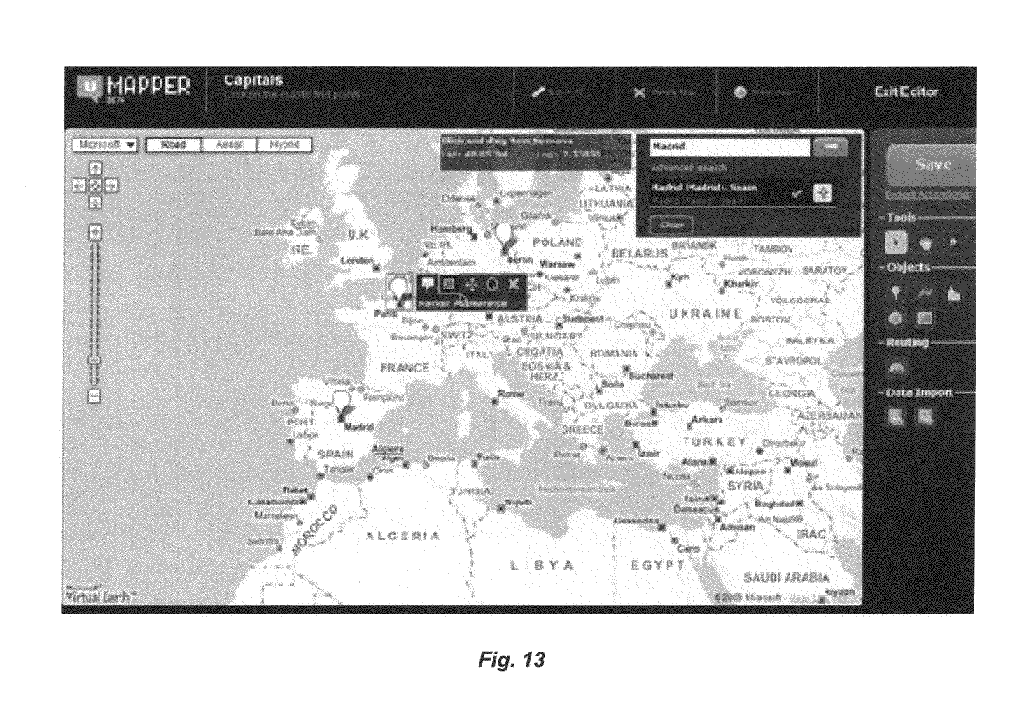

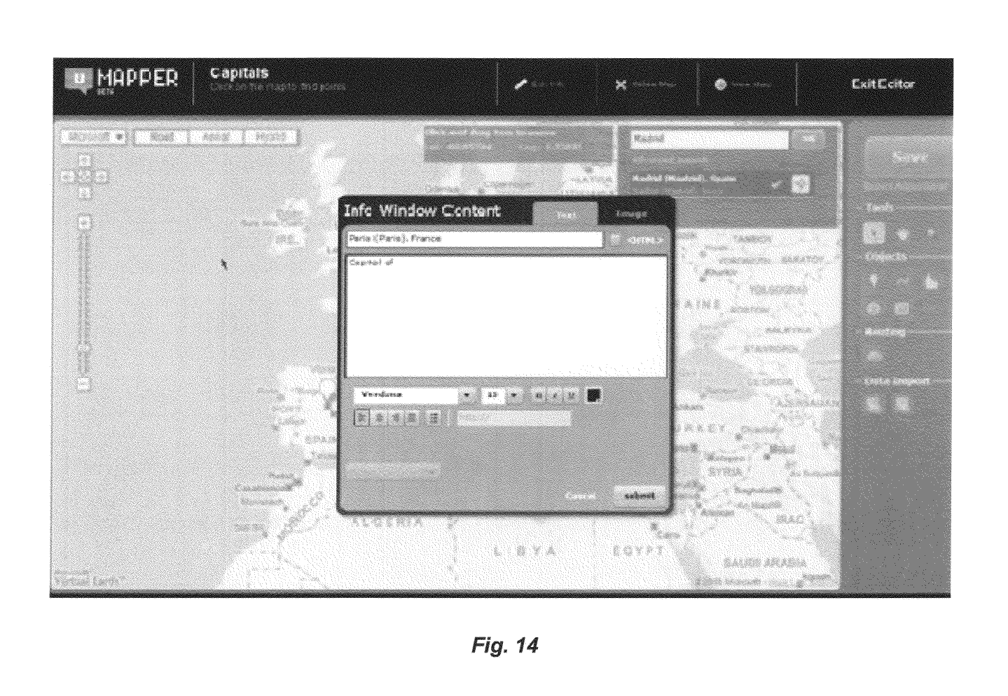

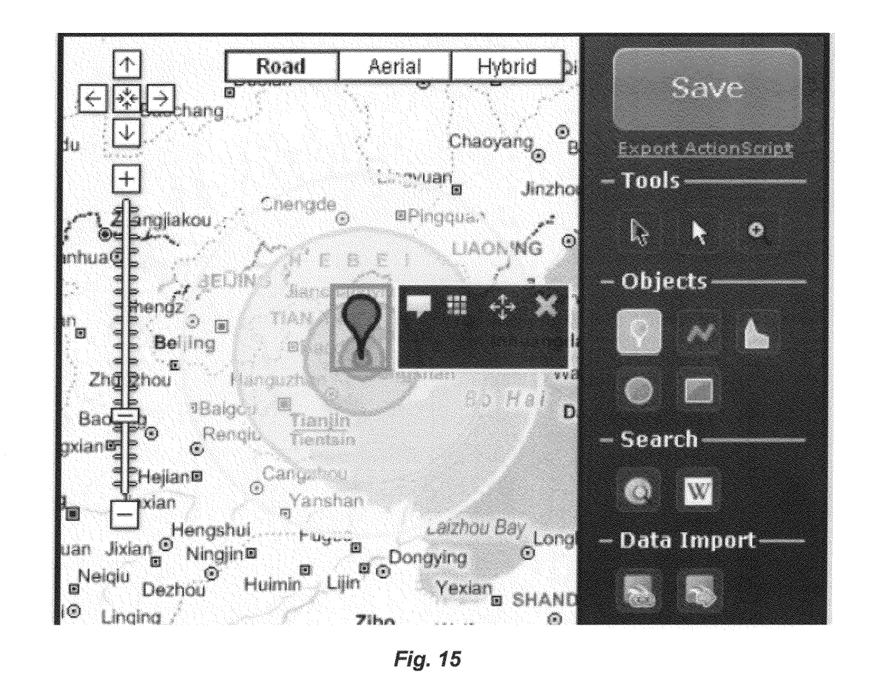

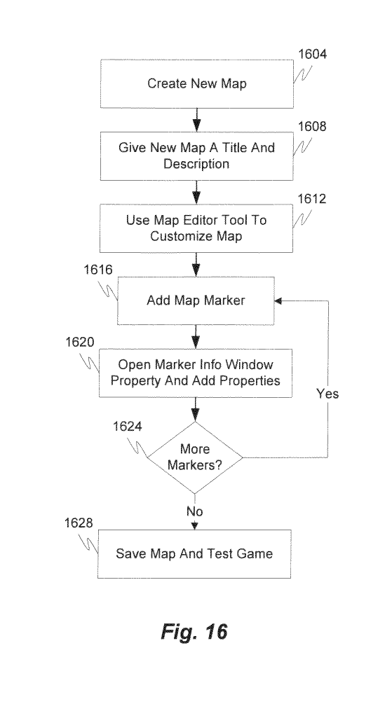

With reference now to FIGS. 8-16, an exemplary method of creating a customized map and/or geogame will be described in accordance with at least some embodiments of the present invention. The method begins when a user decides to create a new map (step 1604). As can be seen in FIG. 8, one type of geogame that may be created by a user is a geodart game whereby a user is invited to answer geography related questions by identifying locations on a map. Alternatively, or in addition, a user may be asked to select areas on a map with a square, rectangle, or polygonal selection tool. As one example, a user may be asked to identify the location of the Nile River. In this example, a user may be required to click and drag across as much of the Nile River as possible. The comparison of actual data relating to the location of the Nile River may be compared with a polygon created by the user's selected area to determine the number of points to award the user.

Once the user decides to create a new map, the user assigns the map a title and description (step 1608). The user may also assign other properties to the customized map such as the ability to convert text or URLs to points on a map. As one example, a user can enter a location name using the map programming module 120 and that text can be converted to a point (or area) on the map. The user may also be allowed to identify other tags for the customized map or geogame, determine if a particular map template is to be used when creating the game, determine sharing preferences/restrictions, determine editing preference/restrictions, and determine which map provider 124 should be used to retrieve map data.

After these initial steps have been taken, the method continues with the user editing the customized map and/or creating a set of game rule sets with a map editor interface provided by the map programming module 120 (step 1612). As can be appreciated by one skilled in the art, the map editor interface may comprise a number of different editing tools, editing objects, routing options, and data import options. As one example, a user can enter a particular location to search for that location within the map data. Once the general location has been identified in the map data, the user is allowed to add a map marker to the same location (step 1616). The map marker is used to identify the selected location in the map data but is also used as the base data for the customized map and/or geogame. More specifically, when a user begins playing the geogame and selects a location, the selected location will be compared to the map marker location rather than the actual location in the map data. As note above, a user can add a point map marker or an area map marker. As can also be appreciated by one skilled in the art, a single map marker may be both a point marker and an area marker. More specifically, every city in the world may be viewed as a single point, particularly when viewing the world from an extremely great distance. If, however, one were to zoom in on a particular city, then that city would begin to appear as an area rather than a point location. In this sense a user may be allowed to identify a location as an area but that area may act as a point location if the user is not sufficiently zoomed in on the area.

In addition to positively identifying locations with the map editor interface, a user may also be allowed to post queries that can be answered by referencing the map data. For example, a user may ask what city is the capital of France. By referencing the map data provided from the map provider 124, the query can be answered in the map editing tool and the user can be directed toward the location satisfying the query.

After the map marker has been added to the customized map or geogame, the user is further allowed to add properties to the newly created marker (step 1620). The types of properties that may be added to a particular marker include, without limitation, names of the marker, whether the marker is to act as a point or area marker at certain zoom settings, what rules are to be applied to the marker, and so on. The method continues by determining if the user wants to add any more markers (step 1624). If this query is answered affirmatively, then the method returns to step 1616. If the query is answered negatively, then the method continues to step 1628 where the user is allowed to save the customized map or geogame and possibly test the geogame or view the map with a map viewer (also provided by the map programming module 120).

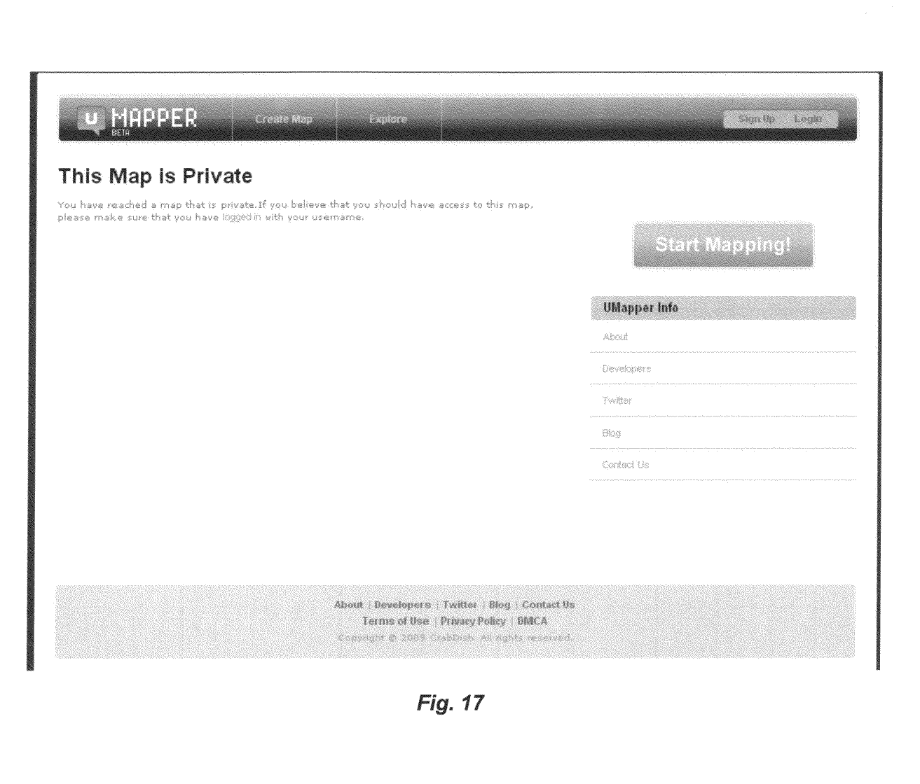

As can be seen in FIG. 17, a customized map and/or geogame may be protected by the creating user. More specifically, the creating user may define access permissions/restrictions and may further identify particular users that are allowed/disallowed access to their map. Thus, without proper authentication (e.g., username, password, etc.) a user may not be allowed to view or utilize a protected map or geogame.

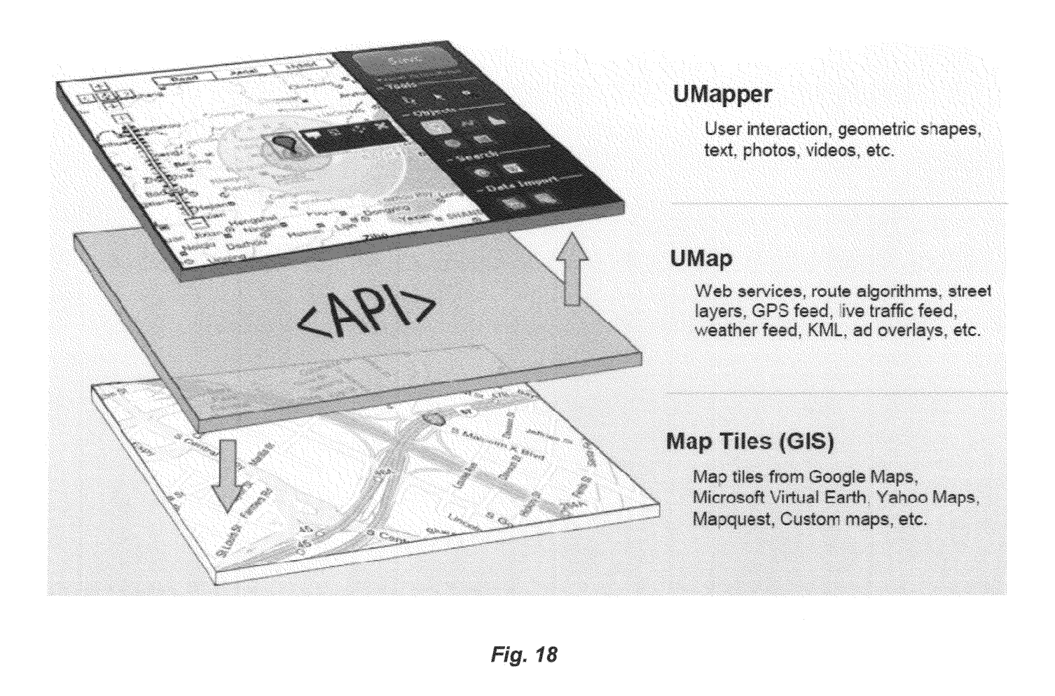

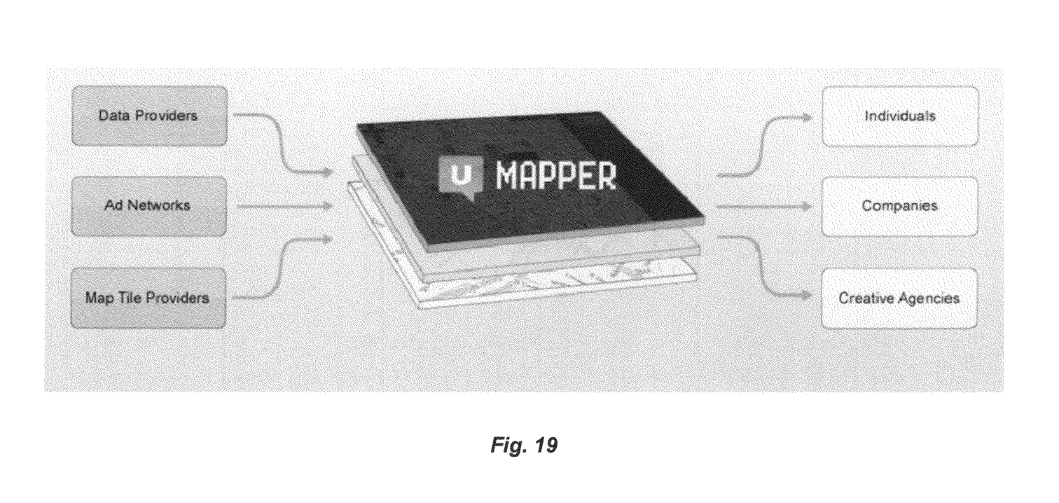

As can be seen with reference to FIGS. 18 and 19, the editing tool supports user interaction, the creation of geometric shapes (map markers), the creation of text, photos, videos, and other customized content. The editing tool interacts with the map data (i.e., map tiles in the form of Geographic Information System (GIS) data) received from a map provider through an API. The API performs web services, executed queries on the map data on behalf of the user, employs route algorithms, identifies street layers, analyzes and conditions GPS feeds, analyzes and conditions live traffic feeds, analyzes and conditions weather feeds, translates Keyhole Markup Language (KML) for the user and communicates with the map provider using KML (which is an XML-based language schema for expressing geographic annotation and visualization on existing or future Web-based, two-dimensional maps and three-dimensional Earth browsers), and inserts ad overlays.

With respect to the advertisement overlays, the API is adapted to receive ad information, such as particular images or videos for display as an advertisement. The ad overlay may be inserted in a customized map and/or geogame either at the discretion of a user or at the discretion of the map data provider 124 or administrator of the web server 116. Accordingly, advertising revenue may be generated by the administrator of the web server 116 in connection with allowing users to access and utilize the map programming module 120.

As can be seen in FIG. 19, the customized maps and/or geogames can be transferred to other individuals, companies, and or creative agencies. The widespread availability of a customized map and/or customized geogame can allow its creator to access a number of different markets with creative and personalized content. In accordance with at least some embodiments of the present invention, the map programming module 120 may be integrated with other types of software platforms such as social networking platforms, news circulation platforms, and other platforms available over the Internet. Furthermore, the map programming module 120 may be used in connection with location aware devices (e.g., mobile navigation systems, GPS systems, etc.) and other map utilization tools.

Additional details related to the packages, classes, and methods within those classes which make it possible to create a customized map, geogame, and/or map-based simulation are provided at http://www.afcomponents.com/content/documentation/umap as3/, the entire contents and sub-contents (e.g., the packages and classes listed in Appendix A of U.S. 61/215,604) of which are hereby incorporated herein by reference. Furthermore, the contents of each class and the methods contained within each class are further described in the computer program listing appendix, which is being filed concurrently herewith on a CD ROM and which is hereby incorporated herein by reference. More particularly, embodiments of the present invention contemplate using one or more packages (having a plurality of classes therein) such as, for example, a control package, a projection package, a core package, a display package, a display geocoder manager package, a marker manager package, a route manager package, an error package, an event package, a gui package, a gui button package, an interface package, a math package, an overlay package, a generic provider package, a plurality of specific provider packages, a style package, and a type package.

While the above-described flowchart and interfaces have been discussed in relation to a particular sequence of events, it should be appreciated that changes to this sequence can occur without materially effecting the operation of the invention. Specifically, a device can address a third party without leaving an existing communication session as long as signaling and addressing occurs outside the audio channel. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and communication arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for easily creating customized maps and map-based games/simulations. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A method, comprising:
receiving user instructions to create a new map using map data;
receiving user instructions to mark a first location on the new map;
associating the first location marked by the user with a corresponding location in the map data;
receiving user instructions for assigning properties to the first location; and
assigning the properties to the first location marked by the user and the corresponding location in the map data.

2. The method of claim 1, wherein the map data comprises first map data, the method further comprising:
replacing the first map data with second map data, the second map data being provided from a second map provider different from a first provider of the first map data;
associating the first location marked by the user with a corresponding location in the second map data; and
assigning the properties to the corresponding location in the second map data.

3. The method of claim 2, wherein the map data includes geolocation data, images associated therewith, and provider settings, the method further comprising:
retrieving the second map data from a URL associated with the second map provider;
parsing the second map data for provider settings; and
allowing the user to access, view, and mark the images based on the geolocation data pursuant to the provider settings.

4. The method of claim 1, further comprising:
receiving a set of user rules for a game to be played in connection with the new map;
applying the set of user rules to the map data and the first location; and
allowing a user to play a game with the new map and the set of user rules.

5. The method of claim 4, wherein the set of user rules are received from the user.

6. The method of claim 4, wherein the set of user rules are received from a game provider.

7. A computer readable medium comprising processor executable instructions operable to, when executed, perform the method of claim 1.

8-12. (canceled)

13. A computer readable medium having stored thereon instructions that cause a computing system to execute a method for conducting an automated customer survey, the instructions comprising:
instructions configured to receive and interpret user input to create a new map using map data;
instructions configured to receive and interpret user instructions to mark a first location on the new map;
instructions configured to associate the first location marked by the user with a corresponding location in the map data;
instructions configured to receive and interpret user instructions for assigning properties to the first location; and
instructions configured to assign the properties to the first location marked by the user and the corresponding location in the map data.

14. The computer readable medium of claim 13, wherein the map data comprises first map data, the instructions further comprising:
instructions configured to replace the first map data with second map data, the second map data being provided from a second map provider different from a first provider of the first map data;
instructions configured to automatically associate the first location marked by the user with a corresponding location in the second map data; and
instructions configured to automatically assign the properties to the corresponding location in the second map data.

15. The computer readable medium of claim 14, wherein the map data includes geolocation data, images associated therewith, and provider settings, the instructions further comprising:
instructions configured to retrieve the second map data from a URL associated with the second map provider;
instructions configured to parse the second map data for provider settings; and
instructions configured to allow the user to access, view, and mark the images based on the geolocation data pursuant to the provider settings.

16. The computer readable medium of claim 13, the instructions further comprising:
instructions configured to receive and interpret a set of user rules for a game to be played in connection with the new map;
instructions configured to apply the set of user rules to the map data and the first location; and
instructions configured to allow a user to play a game with the new map and the set of user rules.

17. The computer readable medium of claim 16, wherein the set of user rules are received from the user.

18. The computer readable medium of claim 16, wherein the set of user rules are received from a game provider.

19. The computer readable medium of claim 13, wherein the instructions comprise an Application Programmers Interface (API).
